(19) United States
(12) Patent Application Publication
(10) Pub. No.: US 2005/0161538 A1
(43) Pub. Date: Jul. 28, 2005

(54) Lance with swinging head for high pressure cleaning equipments

(75) Inventors: Giovanni Cattaneo, Mozzo (Bergamao) (IT); Gianni Padrin, Gallarate (Varese) (IT)

Correspondence Address: YOUNG & THOMPSON, 745 SOUTH 23RD STREET, 2ND FLOOR, ARLINGTON, VA, 22202, US

(73) Assignee: INTERPUMP CLEANING S.P.A. - DIV. FAIP, VAIANO CREMASCO (CREMONA) (IT)

(21) Appl. No.: 11/023,362

(22) Filed: Dec. 29, 2004

(30) Foreign Application Priority Data
Jan. 23, 2004 (IT) MI2004A000093

(51) Int. Cl. B05B 3/06

(52) U.S. Cl. 239/587.4

(57) ABSTRACT

A lance with swinging head (10) for high pressure cleaning equipments, includes: a tubular body (12) connected to the flexible duct coming out of said equipment on one side and,, to the other side, to a cylindrical shaped body (16) and to a nozzle (18) provided with an axial hole (42) with an end throat (42′). The body (16) is provided with an axial drilling with differentiated and increasing diameters starting from its rear end connected to the tubular body (12) towards the opposite front end (22) facing the nozzle (18) and defines, in correspondence with the front end (22) facing the nozzle (18), an annular and shaped seat housing a substantially hemispherical head (34) integral with the same nozzle, partly delimited by a ring (20) fastened to the front end (22) of the body (16).

The present invention refers to a lance with swinging head for high pressure cleaning equipments.

More particularly, the present invention refers to a lance, constituted by a stiff tubular body, whose free front end incorporates a swinging head to direct the water flow coming out of it. Said lance with swinging head is particularly suitable for the use on high pressure cleaning equipments, which are generally called hydrocleaners.

It is known that, especially for cleaning floors, great surfaces and vehicles, high pressure cleaning equipments manufactured according to different types depending on their use which can be for professional/industrial or hobby purposes are used.

These equipments comprise an electrically powered engine-pump group and an inlet duct and an outlet one for the fluid, which is generally water with the addition of detergent, degreasing and/or polishing substances. A flexible duct whose free end is associated to a command device to deliver the pressurized fluid is connected to the outlet duct. This command device generally consists in a gun and in one or more stiff tubular lances which can be interchanged among them. The latter comprise an end head integrating a nozzle which can be adjusted by means of a ring or the like to deliver the fluid as a more or less concentrated jet.

In some embodiments the head bearing the nozzle can be angularly swung in order to direct the water jet and avoid the user uncomfortable movements or positions. These kinds of situations generally occur, for example, when washing the underbody and the wheelhouse of vehicles, in fact a stiff lance extending in a rectilinear way could reach all the points only with uncomfortable movements and torsions of the user.

Therefore, the known swinging heads of the lances show some considerable drawbacks.

One of these drawbacks is due to the fact that the angular positioning of said heads can take place only according to preset and limited positions. This positioning, in fact, generally involves two diametrically opposed points or at least four points placed at 90° among them. Sometimes this limit can force the user to rotate the lance with difficulty in order to obtain the required jet angle under pressure. Moreover, the same angular positioning of the head in one of the preset points is difficult. The user in fact is forced to do a great effort to rotate the head which, during the working of the hydrocleaner is subject not only to the internal pressure of the fluid, but it is also fixed in position by elastic projections or notches.

Therefore the change operation concerning the angular direction of the head is difficult and the user is forced to previously stop the delivery of the water flow under pressure.

Object of the present invention is to remove the above-mentioned drawbacks.

More particularly, object of the present invention is to provide a lance for high pressure cleaning equipments or hydrocleaners wherein the head bearing the dispenser nozzle can be directed into any direction compared to the rear stiff tubular duct making the body of the same lance.

A further object of the present invention is to provide a lance as defined above, wherein the angular variations of the head bearing the dispenser nozzle can be easily and continuously manufactured according to the specific cleaning needs without previously interrupting the delivery of the pressurized fluid.

A further object of the present invention is to provide a lance for hydrocleaners wherein the head bearing the nozzle is automatically fixed into any angular position.

Another further object of the present invention is to provide the users with a lance for hydrocleaners with swinging head apt to assure a high level of resistance and reliability in time, which can be also easily manufactured at low costs.

According to the present invention, these and other purposes are reached by a lance with swinging head for high pressure cleaning equipments comprising: a tubular body connected to the flexible duct coming out of said equipment from one side and to the other one by a cylindrical shaped body, for example by thread and/or a fast coupling, and a nozzle provided with an axial hole with end throat wherein said tubular body is provided with axial drilling with differential and increasing diameters from its rear end, connected to the tubular body towards the opposite front end facing said nozzle and defines, in correspondence with said front end facing said nozzle, an annular and shaped seat housing a substantially hemispherical head integral to the same nozzle and partly delimited by a ring fastened with a thread or equivalent means to the front end of said body.

The manufacturing and functional features of the lance with swinging head for high pressure cleaning equipments of the present invention will be better understood from the detailed description which follows wherein reference is made to the Figures of the attached table of drawings representing a preferred and non-limitative embodiment wherein:

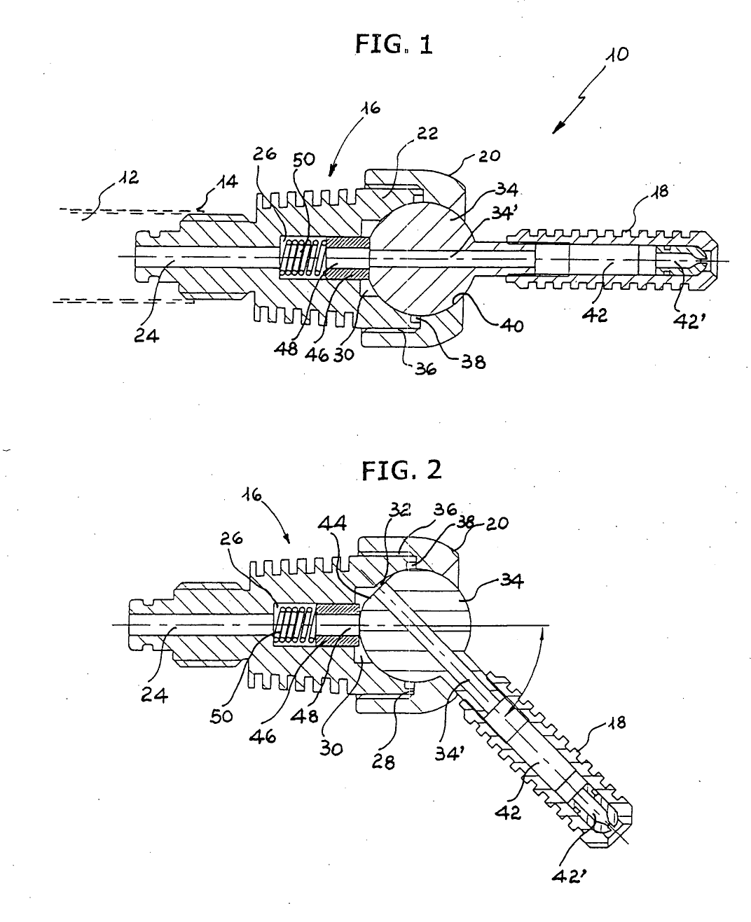

FIG. 1 schematically shows a longitudinal section of the head of the lance of the present invention directed in parallel with the same lance, and

FIG. 2 is a schematic view of a longitudinal section of said head which is angularly directed compared to the same lance.

With reference to the above-mentioned Figures, the lance with swinging head of the present invention, marked in its whole with 10 in FIG. 1, comprises a tubular body 12 which is known in itself, made for example of plastic material, whose rear end is usually connected to the flexible feeding tubular duct of the fluid coming out of the high pressure cleaning equipment (which is not shown).

The opposite front end 14 of said lance is coupled, for example by thread and/or by means of a fast coupling, to a cylindrical shaped body 16 making the support of the dispenser nozzle, marked with 18. Said dispenser nozzle is connected to the shaped body 16 by means of a ring 20 or equivalent means to form the swinging head together with the same shaped cylindrical body 16. Said cylindrical shaped body 16 is provided with an axial drilling with differentiated and increasing diameters from its rear end connected to the tubular body 12 towards to opposite front end, marked with 22, housing the nozzle 18 and the means for its angular direction which will be described here below. In particular, the cylindrical shaped body 16, having for example a circular base, is provided with an axial hole 24, which, from the rear end to which the tubular body 12 is connected, extends into the same body for a portion which approximately corresponds to the half of its longitudinal development and, therefore, extends, thus remarkably increasing its diameter, to form a circular base chambering 26. Said chambering 26 comes out into a shaped and annular seat, formed in correspondence with the front end 22 of the body 16, delimiting a mouthpiece 28 suitable to house the dispenser nozzle 18 and the relevant means for its angular swinging in any direction.

Said annular seat comprises a first area 30, which is substantially bell-shaped, placed in direct communication with the chambering 26 and having a diameter noticeably higher than the one of said chambering 26, and a second close area 32 with a curved-concave profile. The dispenser nozzle 18, of any shape and/or size in its part projecting from the body 16, is matched with a substantially hemispherical head 34 having dimensions to exactly match with said second area 32 with a curved-concave profile of the body 16.

A ring 20 is associated to said body 16 whose rear end facing the same body is provided with an internal thread 36. The thread 36 engages along the external side surface of the body 16 which is correspondently threaded in its front end part delimiting the annular seat formed by the first area 30 and the second area 32. Near the thread 36, the ring 20 is provided with a shoulder matching with the mouthpiece 28 of the body 16. Along said mouthpiece 28 it is advantageously placed at least one gasket 38, for example a toric ring one, matching with the head 34. From the mentioned shoulder, defined by a collar which is orthogonally directed with respect to the longitudinal axis of the ring 20 and of the body 16, said ring 20 defines, in the part facing the nozzle 18, an internal curved-concave profile 40 which, together with the second area 32 of the annular seat of the body 16, defines a substantially hemispherical chambering wherein the head 34 of the dispenser nozzle 18 can freely move. Said head 34, advantageously, is integrally obtained by moulding with the nozzle 18 configuring a tubular projection provided with an axial hole 42 with an end throat 42′ which is variously configured and/or sized according to the type of water jet to be obtained during the delivery.

In correspondence with said end throat 42′, the nozzle 18 can be provided with means, which are known in themselves, to adjust the outcoming water flow as for concentration and/or position.

The axial hole 42 of the nozzle 18 extends into a duct 34′ preferably with a lower diameter of the head 34. Said duct 34′ is in communication with the first area 30 and, if required, with the second area 32 of the annular seat formed at the front end of the body 16. The head 34, in its part which is diametrically opposed to the nozzle 18, is provided with a flattening 44, circumscribing the mouthpiece of the duct 34′. The chambering 26 houses a spacer 46 constituted by a cylinder made of plastic or other suitable material, provided with an axial pass-through hole 48 in communication with the hole 24 and with the first area 30 of the annular seat of the body 16. Said spacer 46 matches with the head 34 of the nozzle 18 and is elastically tensioned by a helical spring 50 or the like placed into the same chambering 26. The pressure of the fluid acts on the helical spring 50 which pushes the spacer 46 tensioning it against the head 34 of the nozzle 18.

In the embodiment given by way of example of FIG. 1, the nozzle 18 and the relevant head 34 are axially directed with respect to the body 16.

In particular the axial hole 24 of the body 16, the axial hole 48 of the spacer 46, the duct 34′ of the head 34 and the hole 42 of the nozzle 18 are exactly aligned among them and the water comes out from the end throat 42′ of the same nozzle.

Said nozzle 18, is automatically fixed in position for the effect of the pressure of the fluid which, inside the body 16, pushes the spring 50 against the spacer 46 and the latter against the head 34, in particular against the flattening 44 of the same head.

FIG. 2 shows by way of example the condition of the nozzle 18 facing downwards, after the angular positioning for example at 45°. The duct 34′crossing the head 34 is not aligned any more with the holes 24 and 48 respectively of the body 16 and of the spacer 46, nevertheless the water can come out of the end throat 42′ as it previously places into the first area 30 of the annular seat of the body 16 and from here it reaches the mouthpiece of the duct 34′ of the head 34. The flattening 44 of said head 34 allows this passage as it does not correspond with the curved-concave profile of the second area 32 of said annular seat. The nozzle 18 is automatically fixed into position as the spacer 46 always compresses the head 34.

In this case, this compression is exerted externally with respect to the flattening 44. Any other position as for the angular direction on the 360° can be reached by the nozzle 18 with the same automatic stabilization effect due to the push exerted by the spacer 46 on the head 34.

As can be seen from the previous description, the advantages obtained by the present invention are clear.

In the lance for high pressure cleaning equipments the nozzle 18 can be swung at 360° thanks to the presence of the substantially hemispherical head 34 and its fixed positioning in any angular direction is automatically assured by the spacer 46 pressing said head 34.

Even though the invention has been described above with reference to one of its embodiments given only by way of non-limitative example, many changes and variants will be clear to a technician according to the above-mentioned description. Therefore the present invention means to include all changes and variants falling within the spirit and the protective scope of the appended claims.

1. A lance with swinging head (10) for high pressure cleaning equipments, comprising a tubular body (12), connected to the flexible duct coming out of said equipment on one side and, to the other side, to a cylindrical shaped body (16), and a nozzle 18 provided with an axial hole (42) with an end throat (42′), characterized in that said body (16) is provided with an axial drilling with differentiated and increasing diameters starting from its rear end connected to the tubular body (12) towards the opposite front end (22) facing said nozzle (18) and defines, in correspondence with said front end (22) facing said nozzle (18), an annular and shaped seat housing a substantially hemispherical head (34) integral with the same nozzle, partly delimited by a ring (20) fastened to the front end (22) of said body (16).

2. The lance with swinging head according to claim 1, characterized in that said axial drilling with differentiated diameters of the body (16) comprises: a hole (24) which from the rear end, to which the tubular body (12) is connected, extends into the same body for about the half of its development and connects to a circular-based chambering (26) with a higher diameter and comes out into said shaped annular seat delimiting a mouthpiece (28) fit for housing the substantially hemispherical head (34).

3. The lance with swinging head according to claim 1, characterized in that said annular shaped seat comprises: a substantially bell-shaped first area 30, which directly communicates with the chambering 26 and has a noticeably higher diameter compared to said chambering, and a second close area (32) with a curved-concave profile complementary to the one of the head (34).

4. The lance with swinging head according to claim 1, characterized in that the ring (20) is provided, near said thread (36) for the connection with the body (16), with a shoulder matching with the mouthpiece (28) of the same body; starting from said shoulder, said ring (20) being provided with an internal curved-concave profile (40) complementary to the one of the head (34), in the part facing the nozzle (18).

5. The lance with swinging head according to claim 1, characterized in that into said chambering (26) a cylindrical spacer (46), provided with a pass-through axial hole (48) communicating with the hole (24) and the first area (30) of the annular seat of the body (16), is placed and is apt to match with the head (34) of the nozzle (18), said spacer being elastically tensioned by a helical spring (50), placed into the same chambering (26) close to said hole (24) of the body (16).

6. The lance with swinging head according to claim 1, characterized in that said axial hole (42) of the nozzle (18) extends into the head (34) into a duct (34′) with a lower diameter communicating with the first area (30) and/or the second area (32) of said annular shaped seat of the body (16).

7. The lance according to claim 1, characterized in that said substantially hemispherical head (34) is provided with a flattening (44) circumscribing the mouthpiece of the duct (34′).

8. The lance according to claim 1, characterized in that the mouthpiece (28) of the body (16) is provided with one or more gaskets (38) matching with said head (34).
